(19) United States
(12) Patent Application Publication
(10) Pub. No.: US 2011/0209665 A1
(43) Pub. Date: Sep. 1, 2011

(54) Care free pet dish

(76) Inventors: Cheryl S. Rizk, Corona, CA (US); Salam K. Rizk, Corona, CA (US)

(21) Appl. No.: 12/660,551

(22) Filed: Mar. 1, 2010

(51) Int. Cl. A01K 29/00; A01K 5/00; A01K 7/00

(52) U.S. Cl. 119/51.5; 119/61.53

(57) ABSTRACT

This invention is a two-piece pet food and water dish that gives the appearance of a single dish. The pet dish invention consists of a water cavity that connects to a water channel. The water channel surrounds a dry island from three sides. The dry island has a boundary wall higher than the outer wall and lip of the water bowl. The food bowl slides freely in one direction inside the dry island walls and rests at the bottom of the dry island. The wide top lip of the food bowl stays higher than the lip of the water bowl, thus leaving a space between the food bowl lip and the water bowl lip, a distance equal to the width of the water channel. This prevents pet food from falling into the water cavity and channel when the pet is feeding or when refilling. Also, the portable food bowl can simply be removed to be cleaned or refilled. This pet food dish has a low center of gravity, is ant proof, holds and isolates food from the water cavity and channel, and can be left unattended for long periods of time.

### BACKGROUND OF THE INVENTION

1. Field of the Invention

The present invention relates to a low profile ant proof pet food and water dish. A semicircular portable food bowl sits inside a dry island within the water bowl space. The food bowl holds pet food and prevents it from falling and contaminating the water cavity and channel at all times. The pet dish is for in-door out-door on demand use, and is accessible to pets during the day and night.

2. Description of the Related Art

In a domestic setting, food dishes are traditionally placed in-door or out-door for pets to eat on demand and left unattended for long periods of time. Pet owners are always demanding a better pet dish designed to help minimize waste and cleaning. There are many types of pet dishes available on the market, but none incorporate all consumer demands in one pet dish. Consumers are still looking for a pet dish that incorporates the following: a low profile design, highly stable, difficult to tip, holds both food and water, easy and simple to maintain, no assembly required, stops pet food from falling into the water bowl, is easily manufactured, low production cost, easy to clean, ant proof, and can be left unattended for long periods of time.

Here is a list of other insect proof pet dishes:

U.S. Pat. No. 5,577,461—Filed May 23, 1995

U.S. Pat. No. 5,632,228—Filed Oct. 20, 1995

U.S. Pat. No. 6,860,229—Filed Sep. 3, 2003

U.S. Pat. No. D448127—Filed Nov. 29, 2000

U.S. Pat. No. 7,219,622—Filed Feb. 24, 2006

U.S. Pat. No. 1,1518,135—Filed Sep. 8, 2006

U.S. Pat. No. 1,0840,119—Filed May 6, 2004

U.S. Pat. No. 6,227,144—Filed Aug. 4, 2000

U.S. Pat. No. 12221784—Filed Aug. 7, 2008

U.S. Pat. No. 11152815—Filed Jun. 14, 2005

U.S. Pat. No. 9,798,388—Filed Mar. 5, 2001

U.S. Pat. No. 4,896,627—Filed Mar. 8, 1989

U.S. Pat. No. 5,165,365—Filed Nov. 25, 1991

While the above-mentioned dishes serve a useful purpose, none address all the previously mentioned needs. However, the present invention addresses each and every one of these demands in a single pet dish.

### BRIEF SUMMARY OF THE INVENTION

This invention combines a pet water and food bowl in one low profile, stable ant proof dish. It is difficult to tip, holds food and water, is easy and simple to maintain, and does not require assembly, has low production cost, is easy to clean, simple to package and ship, can be carried as one piece, can be left unattended for long periods of time, and is simple to use. The water cavity and channel prevents ants and crawling pests from contaminating the food or consuming it. The food bowl holds and prevents pets food from falling and contaminating the water channel and cavity when the pet is feeding or when one is refilling the food bowl. When refilling or cleaning the food bowl, the versatility of the design allows the pet owner to either remove the food bowl or leave it in place. If the pet owner overfills the food bowl, the excess food will fall out side the dish bypassing the water channel.

### BRIEF DESCRIPTION OF THE SEVERAL VIEWS OF THE DRAWINGS

FIGS. 1, 2, 3, 4, 5, 6, 7.

FIG. 1 is a perspective view of the present invention.

FIG. 2 is an exploded perspective view of the present invention.

FIG. 3 is a top plan view of the present invention.

FIG. 4 is a cross section view of FIG. 3 taken along section lines 4-4.

FIG. 5 is a cross section view of FIG. 3 taken along section lines 5-5

FIG. 6 is an exploded view rendered of the present invention.

FIG. 7 is a perspective view rendered of the present invention.

### DETAILED DESCRIPTION OF THE INVENTION

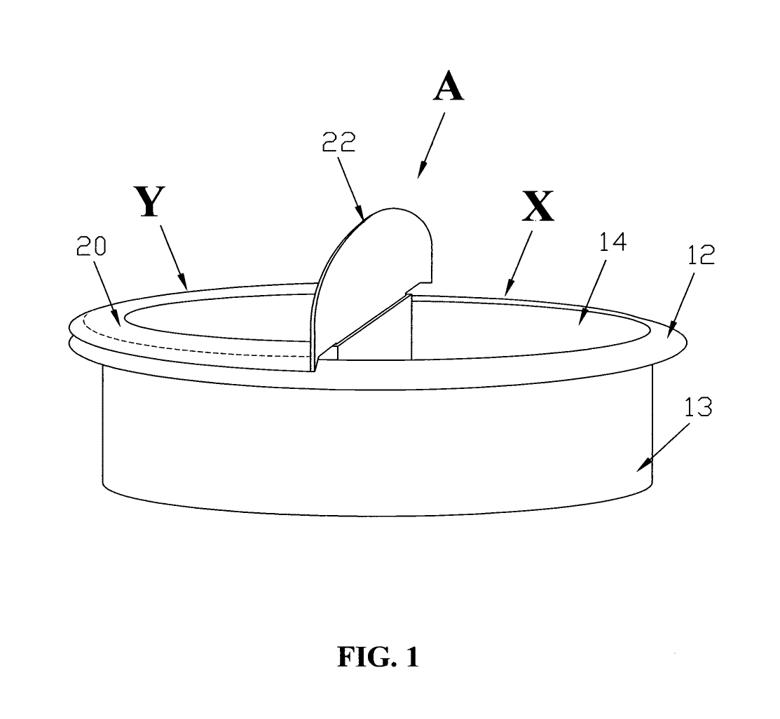

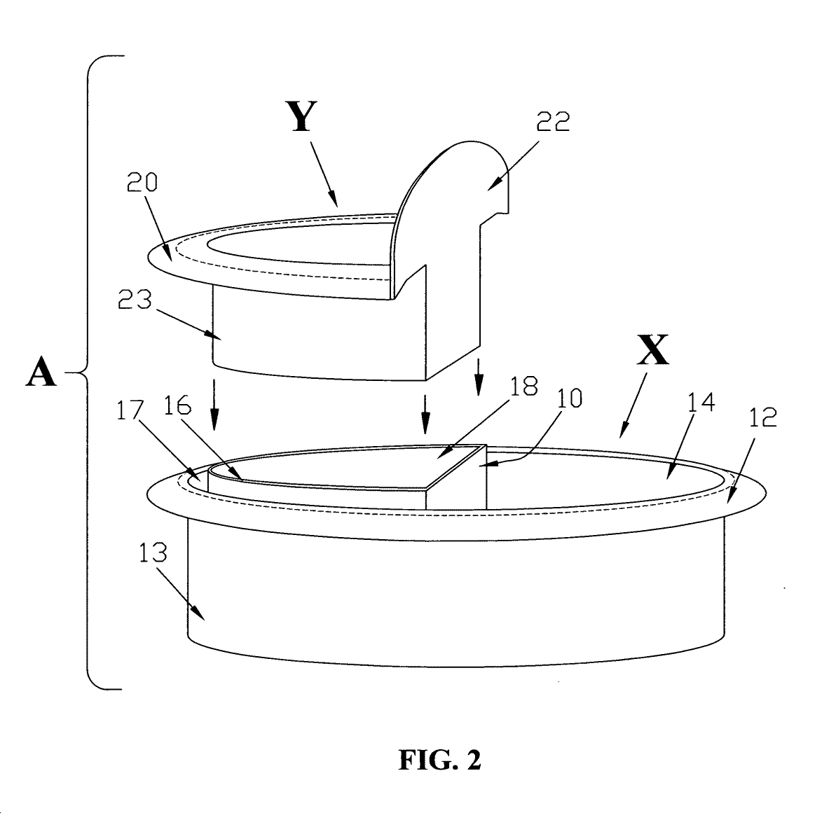

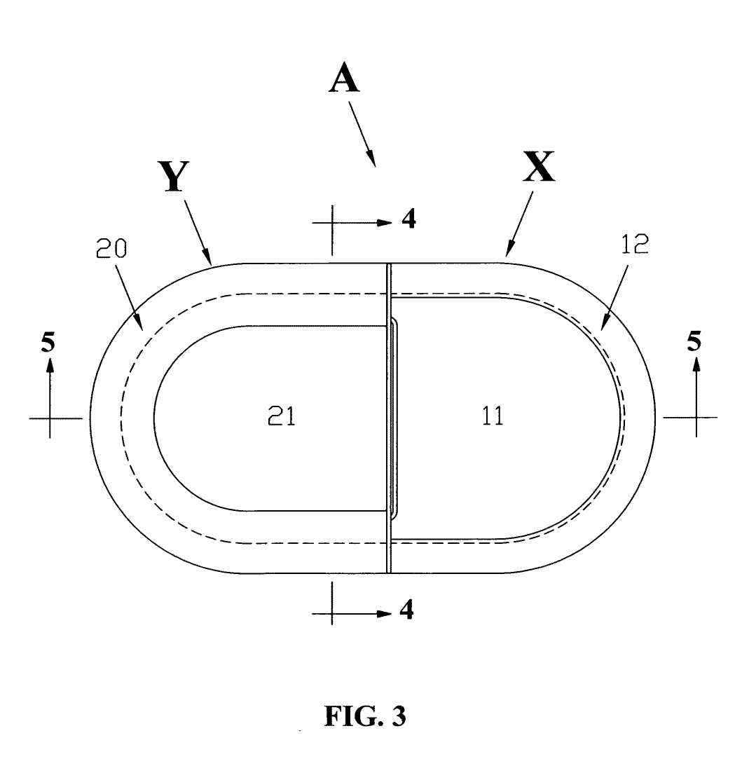

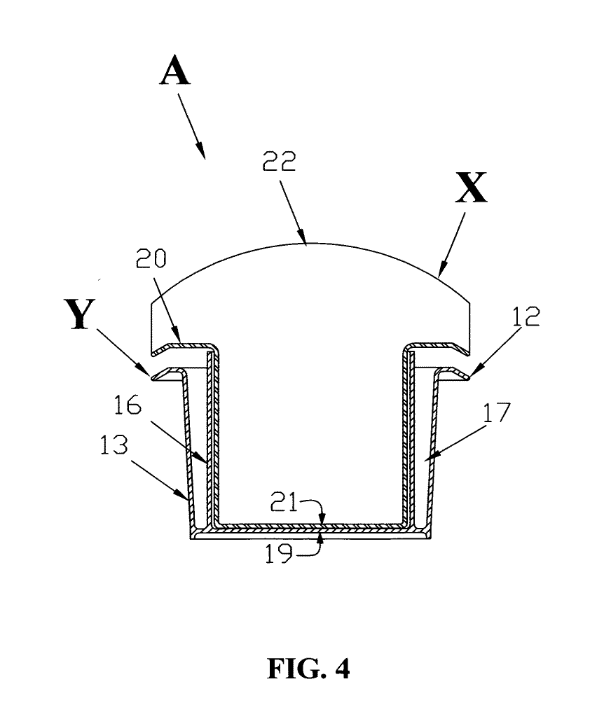

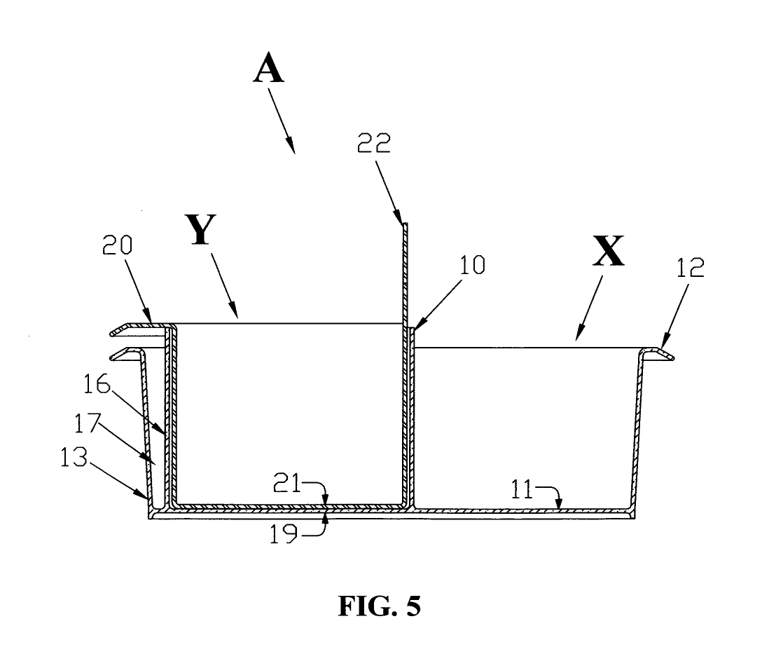

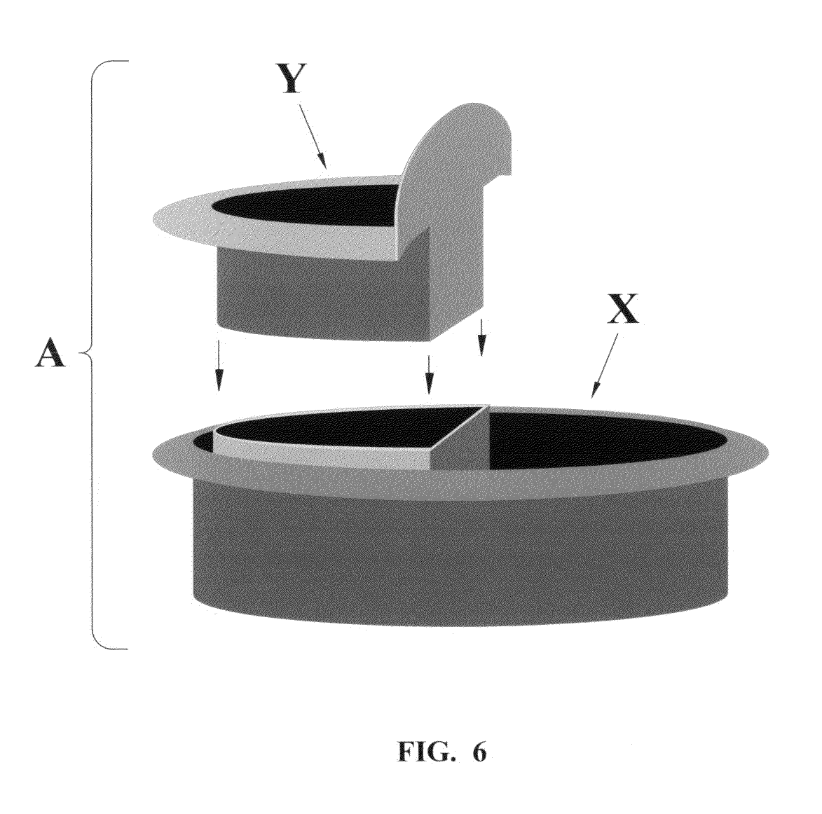

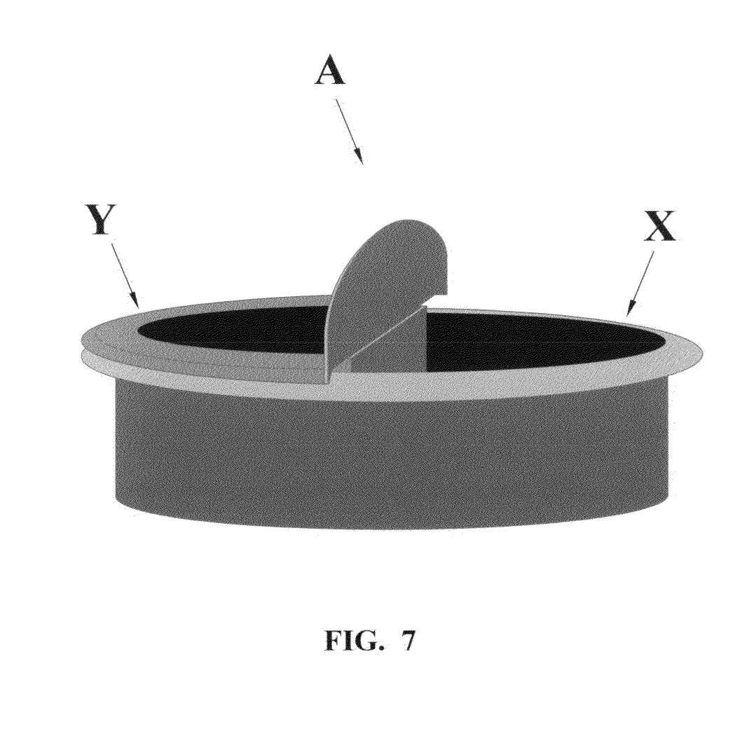

Referring to FIGS. 1, 2, 3, 4, 5, 6, and 7.

In all the FIGS. the pet-feeding dish is referred to by letter A. The pet feeding dish consists of two molded parts, water bowl X and a food bowl Y.

Water bowl X has an elliptical wall 13, and an outer top lip 12, consisting of three spaces; a water cavity 14, a dry island 18, and a water channel 17.

The water cavity 14 has an outer wall 13, a common wall 10, a top outer lip 12, and a bottom 11.

The dry island 18 has one elliptical sidewall 16, one straight vertical wall 10, and a bottom 19. Walls 10 and 16 are higher than wall 13 of the water bowl X and its lip 12.

The water channel 17 is formed by the exterior wall 13 of water bowl X, and the dry island elliptical wall 16.

The food bowl Y has an elliptical wall 23, an outer lip 20, a bottom 21, and a straight vertical back wall 22 extending 2″ to 4″ above lip 20.

The food bowl Y sits inside the dry island 18 where the bottom 21 of the food bowl Y sits on the bottom 19 of the dry island 18.

Lip 20 of the food bowl Y and the lip 12 of the water bowl X line up vertically, and stay apart at a distance (¾″ to 1½″) equal to the width of the water channel 17.

When the food bowl Y is placed inside the dry island 18, the food bowl Y becomes ant proof since the dry island 18 is surrounded by the water channel 17 and water cavity 14. Pet food will not fall and contaminate the water channel 17 because the top lip 20 of the food bowl Y extends beyond the water channel 17 to a point where it is in vertical alignment with lip 12, where any excess food will bypass lip 12.

Also, the food will not fall in the water cavity 14 because wall 22 will prevent the pet food from falling inside food bowl Y at all times.
This pet dish can be manufactured with two-part injection molding or sheet metal at a low cost.

1- This invention is a two part low profile pet dish designed to keep ants and crawling insects away from pet food, and prevents pet food from falling in the water cavity and channel. The invention consists of:
a. A water cavity connected to a water channel, which surrounds a dry island.
b. A dry island with a boundary wall higher than the outer lip of the water bowl.
c. A portable food bowl that sits inside the dry island.

2- The food bowl of claim 1 is designed to slide inside the dry island cavity in one direction.

3- The food bowl of claim 1 has a wide lip vertically aligned with the water channel lip preventing excess food from falling inside the water channel.

4- The wide lip of the food bowl of claim 3 stay at a distance above the lip of water bowl equal to the top width of the water channel.

5- The food bowl of claim 1 has a high back wall to prevents pet food from falling into the water cavity.

6- The dry island of claim 1 is designed to secure the food bowl in place in one direction.

7- The dry island of claim 1 has walls higher than the outer wall of the water bowl. This prevents water from entering the dry island from the water cavity and channel.
